(19) United States
(12) Patent Application Publication
(10) Pub. No.: US 2012/0325394 A1
(43) Pub. Date: Dec. 27, 2012

(54) METHOD AND DEVICE FOR APPLYING PROTECTIVE FILM CONSISTING OF A HOT-MELT ADHESIVE

(75) Inventor: Martin LINNENBRINK, Apensen (DE)

(73) Assignee: SIKA TECHNOLOGY AG, Baar (CH)

(21) Appl. No.: 13/542,264

(22) Filed: Jul. 5, 2012

Related U.S. Application Data
(62) Division of application No. 12/610,475, filed on Nov. 2, 2009, now abandoned.
Application No. 12/610,475 is a continuation of application No. 10/584,913, now abandoned.

(30) Foreign Application Priority Data
Jan. 5, 2004 (EP) 04000054.9

(51) Int. Cl. B32B 37/06; C09J 177/00; C09J 131/04; C09J 123/02; C09J 123/12; C09J 123/06; C09J 175/04; C09J 167/00

(52) U.S. Cl. 156/85; 156/322; 156/330.9; 156/331.7; 156/327; 156/499; 528/85; 528/363; 528/271; 526/348; 526/351; 526/352; 526/331; 156/332; 156/334

(57) ABSTRACT

The invention relates to a single-ply protective film that is devoid of a supporting material and consists of a hot-melt adhesive. Said film can be rapidly and easily applied. The invention also relates to a method for applying said film and to a corresponding device.

### TECHNICAL FIELD

The invention relates to a protective film in accordance with the features of the preamble of claim 1 and also to a method and a device for applying such a protective film in accordance with the features of the preamble of claims 7 and 14.

### PRIOR ART

For transporting, distributing, and storing products it is generally necessary for these products to be protected. This begins with small consumer materials such as toothbrushes and newspapers, and continues through insulating materials for architectural facings and onto automobiles.

Packaging with films has been conventional in this field for a substantial time. In this field, the products are not only wrapped in the films or covered with them. Through the use of films which shrink under the effect of heat it is possible to shrink the film onto the item to be packaged.

One example of shrink film packaging of this kind is shown in FR 2 576 824 for paper bags. Prior to their transport, the paper bags are piled together in large stacks and subsequently passed through a film curtain in such a way that the film surrounds the stack below, above on the front face and rear face. The film web in that case is of excess width and overhangs the stack by some distance on either side. When the stack is being passed fully through the film curtain, the film is welded behind the stack, to form a film tube surrounding the stack. Subsequently the stack is conveyed through a heat box, the film shrink-fits onto the stack, and the overhanging sides fused together, thereby producing packaging which seals the stack.

As a form of “packaging” for automobiles, for the purpose of their transport from the production site to the dealer and eventually to the customer, preservation with paraffin waxes is nowadays being used in an ever greater majority of cases. Preservation with paraffin waxes has the disadvantage that, when the paraffin wax is applied by means of a spray curtain, different coat thicknesses are produced. Moreover, without masking off, it is impossible to prevent contamination of unwanted zones during the spraying operation. This is very disadvantageous. Furthermore, the removal of the wax is time-consuming and very expensive on account of its poor environmental compatibility.

Shrink-wrapping using prefabricated shrink-on films has not gained a foothold so far for automobiles, since the application of the films is very costly and inconvenient. Shrink-on films of this kind are composed of a thermoplastic film and a nonwoven. In order to allow the masked cars to be moved on the site and during delivery, it is necessary to manufacture the covers with zip fasteners to fit the particular model, which is expensive. However, even the opening and closing of the zip fasteners must be done with care and costs time.

Self-adhesive protective films of the kind proposed in recent times for application to automobiles or vehicle parts are of at least two-ply construction, as described in DE 100 29 489 A1, DE 100 07 060 or else in DE 197 42 805. This means that the production of the self-adhesive protective film is associated with a certain cost and inconvenience, since it is necessary to prepare the individual layers separately in their composition and then to combine them to give the aforementioned film. In other words, the backing is produced first of all, then, generally, an adhesion promoter is applied to it, and subsequently the self-adhesive composition is applied. Since the protective films are generally in the form of prefabricated webs, it is the case here again that application is not entirely unproblematic, particularly if the web width is not optimally matched to the width of the model of automobile. If, furthermore, titanium dioxide or other pigments are used as light stabilizers to protect against UV radiation, then the windows must be kept clear of protective film so that the vehicles can still be moved without hazard.

Another kind of self-adhesive protective films is based on a dispersion and can be applied by spraying. Spray application in this case may be accomplished by way of a spray curtain, in a manner similar to that described in EP 1 252 937 A1, for example, or else may take place, in a very targeted way, by means of robot-controlled spraying nozzles. In order for it to cure, this kind of film must be briefly heated to relatively high temperatures; therefore, the only articles which can be packaged using it are those which are able to withstand these temperatures without damage. Although robot spray application achieves a decidedly high spraying accuracy, it is nevertheless necessary with this kind of self-adhesive film either to seal off gaps in the case of windows and doors, or to keep a sufficient distance from them. It is necessary to do this because the dispersion applied in liquid form by spraying penetrates gaps of the kind present, for example, in the case of the doors or the engine hood.

Removing the self-adhesive protective film produced in this way from the gaps again after it has dried off and formed a film, and cured where appropriate, is very costly and inconvenient or even impossible, however, particularly since it is impossible for a coherent sheet to be formed in said gaps. Since, moreover, titanium dioxide and other pigments are employed for UV protection in these protective films as well, it is necessary here again to keep the windows free. In the case of spraying robots it is possible to achieve this by means of corresponding programming adapted individually to each model. When using a spraying curtain, the windows must be masked off beforehand, which is associated with a corresponding labor effort. Furthermore, as a result of what is called the overspray, a large amount of material is consumed unnecessarily.

Since the properties of the spray-applied self-adhesive film are extremely dependent on its composition, it is almost impossible, even in the case of water-based dispersions, to produce the dispersion on site, e.g. to mix it with water. This means, however, that the product, namely the dispersion, to be transported by the manufacturer to the site of application, is composed to a large part of water, and this has a very adverse effect on the environmental balance. Likewise disadvantageous for the environmental balance is the mandatory drying step, since here again a large amount of energy is consumed. Furthermore, the disadvantage exists that dispersions fundamentally have problems of storage stability. In particular it is known that temperatures below 0° C. are extremely problematic for dispersions.

### Outline of the Invention

It is an object of the present invention, therefore, to provide a protective film which is easy and inexpensive to apply, in particular not least to automobiles and vehicle parts, and also a method for its application and a suitable device for the application.

This object is achieved by a protected film in accordance with the features of claim 1, a method in accordance with the features of claim 7, and a device in accordance with the features of claim 14.

A protective film which is produced in single-ply, unbacked form from a hot-melt adhesive can be applied virtually at the same time it is produced, which is quick and inexpensive. Since the protective film bridges gaps instead of penetrating into them like a dispersion, it is unnecessary when applying the film to mask off gaps or maintain distance from them.

### Ways of Performing the Invention

The invention relates to a protective film of plastic which is produced in single-ply unbacked form from a hot-melt adhesive.

By “unbacked” is meant throughout the present specification that there are no additional backing materials whatsoever, such as nonwovens or silicone paper, for example, in the protective film.

If the protective film is self-adhesive then application is even easier and quicker and extends the possibilities for use. By “self-adhesive” is meant, here and below, that the film is self-adhesive at the application temperature, whereas at a temperature below 60° C. its surface is not tacky. For many end uses a transparent protective film is desired, and this can also be achieved with the choice of the appropriate hot-melt adhesive.

Base materials which have proven suitable for the self-adhesive protective films of the invention include thermoplastic hot-melt adhesives of compounds selected from the following group, encompassing thermoplastic polyurethanes, thermoplastic polyamides (PA), thermo-plastic copolyamides, thermoplastic polyesters (PES), thermoplastic copolyesters, thermoplastic ethylene-vinyl acetate copolymers (EVA) or else thermoplastic polyolefins. Among these, in particular, atactic poly-α-olefins (APAO), polypropylene (PP) or polyethylene (PE). Also conceivable are hot-melt adhesives based on a combination of the above mentioned thermoplastics.

Reactive hot-melt adhesives, such as reactive PUR or reactive polyolefins, for example, are likewise suitable for the self-adhesive protective film. With these substances or combinations of these substances, however, it must be borne in mind that ambient parameters, such as humidity and others, have an influence on the curing process. Applications under constant or controllable conditions are therefore preferred here.

Given the choice of the appropriate hot-melt adhesive for the protective film of the invention, said film, as in the case of the dispersion-based protective films or those applied to a backing, can likewise be removed again without residue from the surface to which it has been applied. This can be done in particular even from paint surfaces and automobiles and even after prolonged weathering. Nevertheless, a certain extent of sticking is needed, so that, for example, the protective film remains stuck to the bodywork surface even in wind.

Hot-melt adhesives which have shown themselves to be preferred are those comprising or consisting of polyester. Particularly suitable polyesters are linear, partially crystalline, saturated copolyesters synthesized from dicarboxylic acids and diols. Suitable diols include, in particular, short-chain alkylenediols, especially butanediol and hexanediol. Particularly suitable dicarboxylic acids include glutaric acid, adipic acid, dodecanedicarboxylic acid, phthalic acid, and isophthalic acid. Polyesters which have particularly suitable are those prepared from mixtures of diols and dicarboxylic acids, or mixtures of polyesters. The polyesters suitably have a molecular weight (MW) of between 10,000 and 30,000 g/mol, in particular between 15,000 and 20,000 g/mol.

The suitable hot-melt adhesives should not to be tacky at temperatures below 60° C., in particular below 70° C., preferably below 80° C. Tackiness in a protective film of this kind would lead to esthetically disadvantageous protective films, since, for example, dust would stick to the film.

Furthermore, both in its fresh form after application and at a later point in time as well, the film should to be able to be removed without residue and should in particular not to damage the surface of the product under protection, in particular an automobile paint. This property must also not be substantially influenced by weathering and aging of the protective film.

With self-adhesive protective films of the invention having a thickness in the range from 2 micrometers to 3 millimeters, in particular from 50 micrometers to 500 micrometers, it is possible to package a very wide variety of articles without problems. The protective film does not tear and conforms very nicely to the outer contours of the product under protection. Film thicknesses of 200 micrometers to 300 micrometers have been found especially suitable in this context.

If the protective films of the invention are self-adhesive and transparent they can be used to cover automobiles without any need to mask off or cut out the windows or to remove the protective film from the automobiles following application. The vehicles can be moved without hazard with the film on the windows, without further measures being taken, on site at the premises of the manufacturer, during transport, and at the retailer until passing to the customer.

In the case of the method of the invention for applying a protective film, a hot-melt adhesive is heated in a primary melting region to application temperature, the application temperature being regulated such that when the hot-melt adhesive flows off from the primary melting region a film of desired width is formed. If, then, an article that is to be protected with the protective film is passed through beneath this film flowing off from the primary melting region, then this article to be protected is covered in a desired manner with the protective film. This method is extremely quick and efficient, since there is no need to prefabricate the protective film and with regard to gaps there is no need to take precautions, since the film covers such gaps and there is no risk of the gaps becoming filled with adhesive.

Optimum packaging of the product to be protected is obtained if, in the context of the method, the film width on emergence from the primary melting region is set such that it corresponds approximately to the width of the product to be protected with the film plus twice the height of the product. Such a film width ensures that the film not only surrounds the article from the front, at the top and on the reverse face but also envelopes the article at the sides. Areas which it may be intended should not be masked off by the film, such as wheels, fuel cap area or, under certain circumstances, windows or headlights, for example, can be cut out without problems. Furthermore, it is very easy if necessary to cut the film applied over gaps without damaging the paint. This is sensible particularly in the case of doors, and also hinged elements of any kind, especially fuel cap cover and engine hood, which have to be opened after the packaging operation, in order, for example, to access the interior of the car or to refuel the vehicle. The protection is not impaired as a result, since the moving parts are likewise protected with a protective film.

In order to prevent oxidation of the hot-melt adhesive it is sensible to melt the hot-melt adhesive in a preliminary melting region, before it is heated in the primary melting region to the application temperature.

The application temperature of the hot-melt adhesive is selected in accordance with the chosen hot-melt adhesive and the temperature, and also with the thermal conductivity of the product to be protected. Typically the hot-melt adhesive is heated to an application temperature in the range from 80° to 250° C. Temperatures which have proven particularly suitable are those between 130° C. and 210° C., in particular between 160° C. and 200° C.

In order to achieve effective wetting of the surface to be bonded with the self-adhesive protective film, the temperature of the surface of the product and the application temperature of the hot-melt adhesive are harmonized with one another such that the temperature difference between the surface and the application temperature is preferably at least 50° C. In this system the surface temperature of the product to be protected ought ideally not to be more than 80° C. and not to be less than 0° C., in particular between 20° C. and 40° C. If, for example, the product to be protected is to be stored outdoors at a temperature below 0° C. and were to be coated immediately with a film in a warmer hall, with ambient humidity, the risk would exist of the formation on the surface of a dew film which would prevent the protective sheet sticking to the surface. In the majority of cases, however, this is undesirable.

Where an article is to be protected all round and not just at the front, on the top, at the sides and behind, with the protective film, the method can be combined with a supporting element which can be moved transversely to the film in a first direction and in an opposite second direction. In that case the supporting element is sensibly given a repellent coating, being for example made of Teflon or coated with Teflon, so that the film does not stick to it. While the supporting element is being moved in a first direction transversely to the film flowing off from the primary melting region, the film is deposited as a sheet of film on the supporting element. The product to be protected is then placed on the sheet of film lying on the supporting element, and the supporting element is moved in the opposite second direction transversely to the film, so that the product becomes covered by the film. As a result the product is surrounded with the film on the bottom, at the front, on the top and at the back. If the film width is selected as described above, moreover, the protruding edges of the film drop over the sides of the article, so that the article is completely enveloped.

Irrespective of whether the article is now covered with the protective film entirely or with the exception of the underside, at the end of the operating step of “covering” the film is cut off to desired length and the next article can be covered with protective film.

For particularly effective sticking to the surface, the article to be protected, subsequent to the covering operation, is treated with hot air. In the course of this operation the protective film of hot-melt adhesive conforms to the outer contour of the article, but without penetrating indentations, gaps, holes and the like; instead, any such discontinuities in the surface are bridged by the protective film. Curved surfaces of concave and convex kind, in contrast, are covered with a precise fit by the film.

In order to be able to apply a protective hot-melt adhesive film of this kind a device is provided which, in a known way, has a heatable container as a part of the primary melting region in which the hot-melt adhesive is heated to its application temperature. Additionally, an application unit is provided which belongs to the primary melting region and via which the liquid hot-melt adhesive flows off in such a way as to form a coherent film of predetermined width and predetermined thickness.

In one preferred embodiment the application unit Lakes the form of a slot die. Also conceivable, however, are two or more small dies alongside one another, the distance of the dies from one another necessarily being made such that as the hot-melt adhesive flows off, a film is formed. The off-flow of the film may in principle be controlled by gravity, in other words the inherent weight of the hot-melt adhesive, but can also take place preferably by means of a pump, under pressure. With particular preference an arrangement known to the skilled worker for the processing of hot-melt adhesive is used in this case, namely the use of a barrel pump with a heatable follower plate or an extruder.

In one particularly preferred embodiment the application unit is provided with a slot die whose slot depth and slot width are adjustable, the film thickness being determined by the slot depth and the width of the resultant film via the slot width. It is particularly advantageous if the slot width is adjustable such that the width of the resultant film corresponds approximately to the width of a product to be protected with the film, plus twice the height of the product. If the slot depth is not adjustable, then it is also possible to influence the film thickness by means of a pressure-controlled flow rate of the liquid hot-melt adhesive through the slot die. In the case of an application unit with a large number of small dies it is possible for the resulting film width to be accomplished by switching the laterally outermost dies in or out, respectively. Whereas the thickness of the film can be adjusted via a change in the size of the die apertures or by means of a variably pressure-adjustable flow rate of liquid hot-melt adhesive. It is also possible in this way to produce, simply, films with local differences in thickness. Furthermore, the sheet thickness can also be influenced by the rate of advance of the product to be protected.

As already described above it may be sensible, particularly for hot-melt adhesives which are susceptible to oxidation at elevated temperatures, to equip the device with a preliminary melting region upstream of the primary melting region, in which the hot-melt adhesive is melted. If this is done then the preliminary melting region is preferably a separate heatable container which communicates via a kind of airlock directly with the container of the primary melting region, so that the melted hot-melt adhesive is able to flow off in accordance with gravity into the container of the primary melting region. Alternatively the two containers may communicate with one another via lines and, where necessary, via a pump system. For certain hot-melt adhesives it is also conceivable to provide a single container for the melting and the heating to application temperature.

It has additionally been found that the protective films can also be printed. This takes place typically only after the film has cooled. The printing ink can be applied by the application technologies known to the skilled worker. Particular suitability is possessed by printing with ink-jet technologies. Atop the protective film it is therefore possible to print, in black or colored, inscriptions, images, and graphics of any kind at all. These imprints preferably have an information or advertising character. Thus it is possible, for example, to apply production data, delivery data or address data at desired points on the film. One particularly preferred version is the application of machine-readable imprints, such as barcodes. On the other hand the films are outstandingly suitable for the application of advertising imprints. In certain circumstances it may be necessary for the film to be subjected to a physical and/or chemical pretreatment in those regions in which an imprint is to be applied. Thus, for example, a corona treatment may be advantageous for polyolefin film materials in order to ensure effective printability. With preference, however, no such pretreatment is necessary.

Further preferred embodiments are subject matter of further, dependent claims.

The subject matter of the invention is illustrated below with reference to preferred exemplary embodiments which are depicted in the attached drawings. Within the figures, identical elements are in principle given identical reference symbols. The embodiments described are exemplary of the subject matter of the invention and have no restrictive effect. In the figures, on a purely diagrammatical basis,

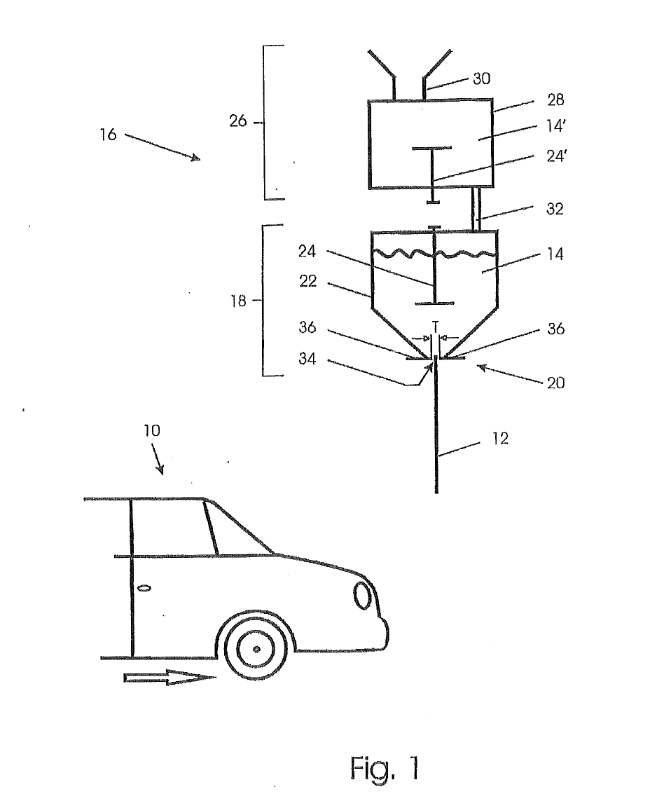

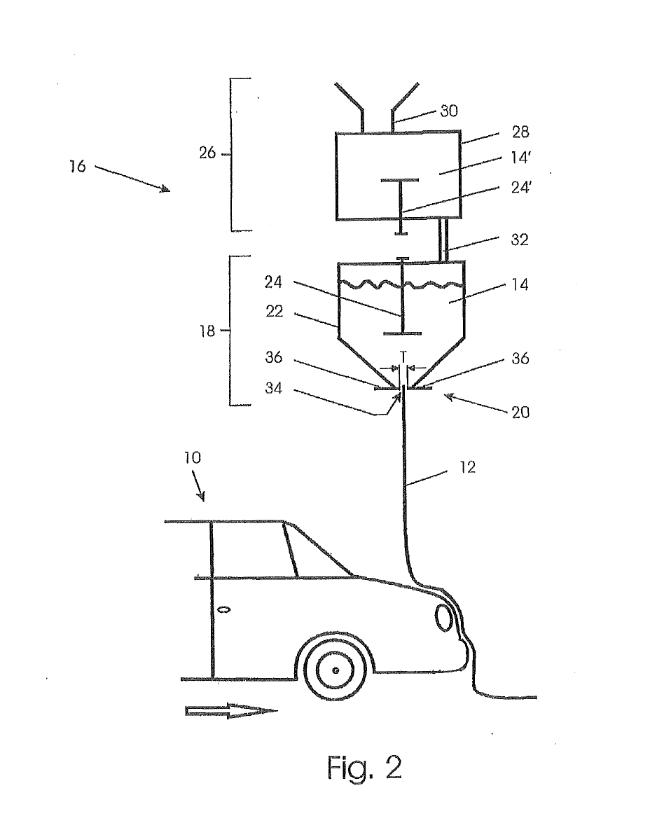

FIGS. 1 and 2 show, from the side, a device for applying a protective hot-melt adhesive film of the invention to an automobile, in two successive stages of application;

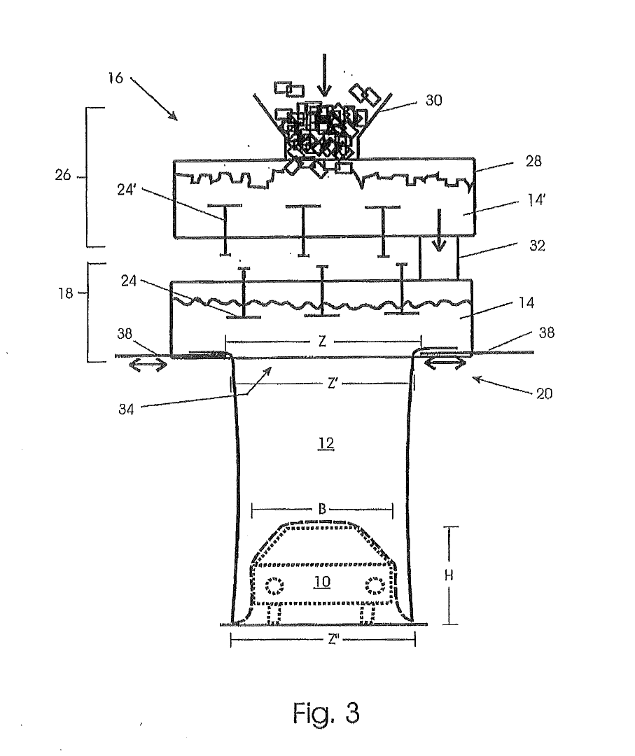

FIG. 3 shows the device from FIGS. 1 and 2 from the front, in a later stage of application;

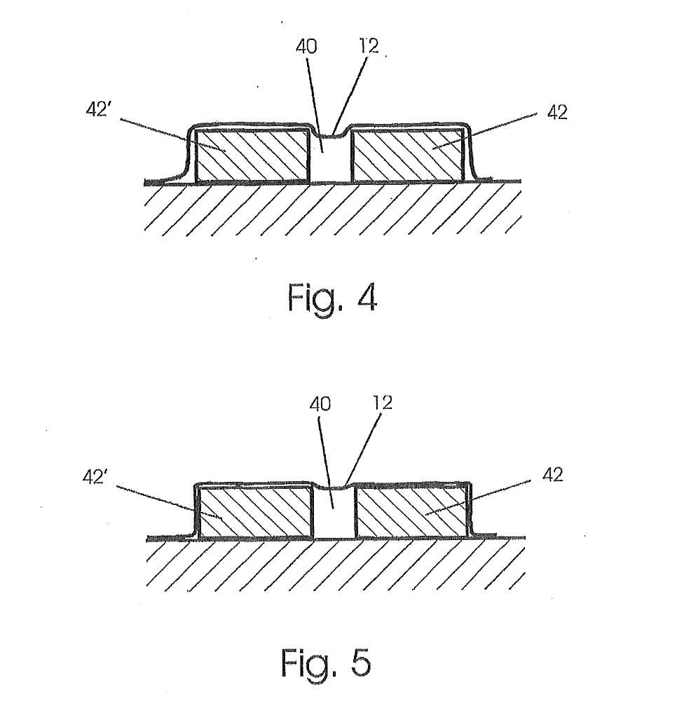

FIG. 4 shows a gap between two fixed elements, covered with a protective film of the invention;

FIG. 5 shows the gap with the protective film from FIG. 4 after treatment with hot air

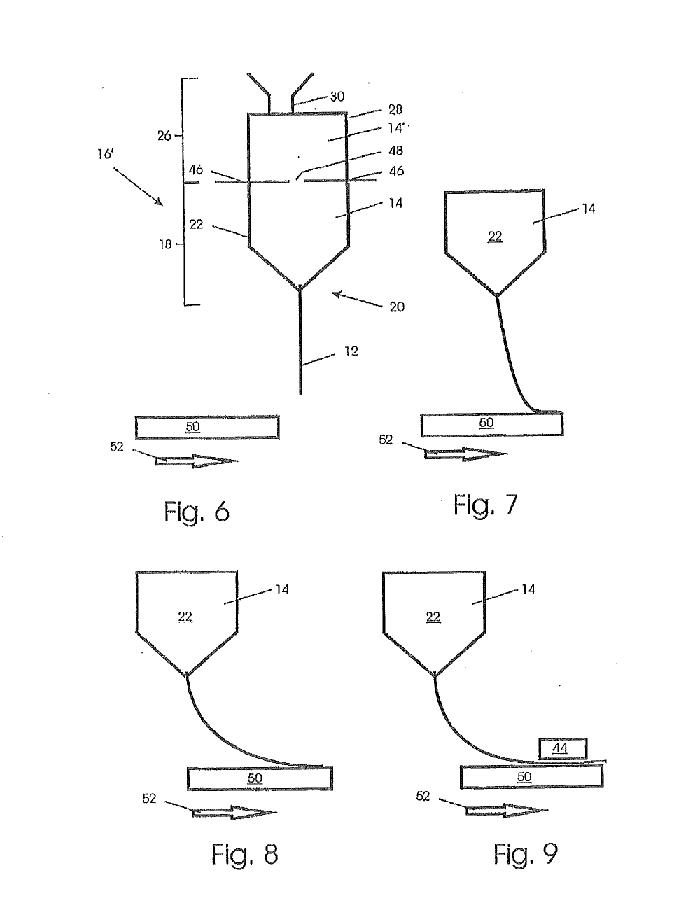

FIG. 6 to FIG. 11 show a further embodiment of a device for applying a protective hot-melt adhesive film of the invention, in various stages of the method;

FIG. 12 shows a hot air station belonging to the device of FIGS. 6 to 11,

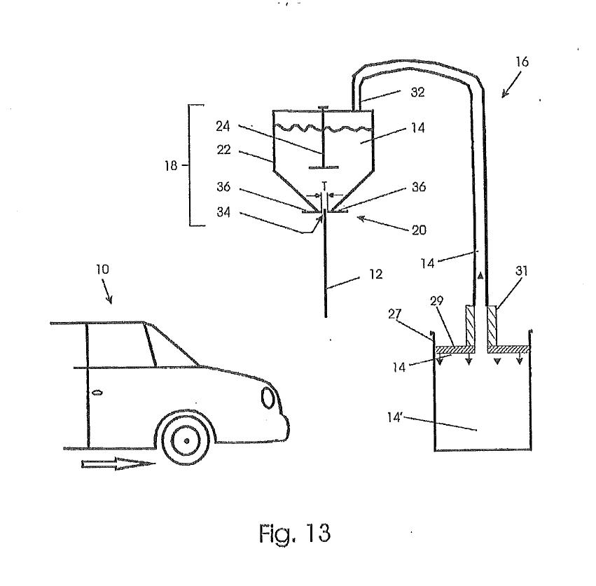

FIG. 13 shows a further embodiment of the device 16 with barrel pump, and

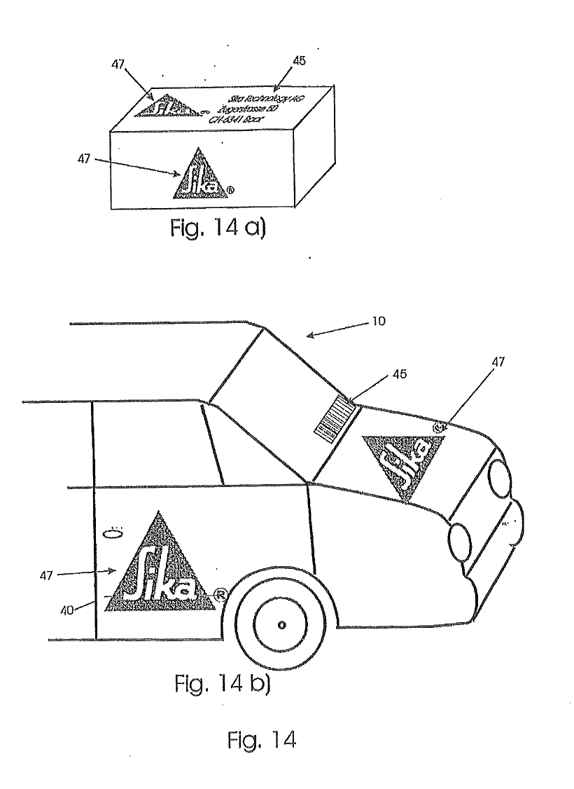

FIG. 14 shows a protective-film-packaged article with imprints
a) article with information and advertising imprints
b) automobile with information and advertising imprints.

FIGS. 1 to 3 show, diagrammatically, an automobile 10 masked with an inventive protective film 12 of hot-melt adhesive 14, 14′. The device 16 for applying self-adhesive protective film 12 comprises a primary melting region 18 with an application unit 20 and with a heatable container 22, which can be equipped with means for stirring 24. In the example shown here, the primary melting region 18 is preceded by a preliminary melting region 26. The preliminary melting region 26 has a heatable melting container 28, if appropriate with means for stirring 24′, and also means for filling 30 the melting container 28. In this example, furthermore, the heatable melting container 28 of the preliminary melting region 26 and the heatable container 22 of the primary melting region 18 are joined to one another by means of a line 32, if appropriate, preferably, via a pump, in such a way that a supplementary flow of the melted hot-melt adhesive 14 in sufficient quantity is ensured at any time.

In the example shown here, the application unit 20 is designed as a direct outlet from the container 22 of the primary melting region 18 and is configured in the form of a slot die 34. The slot depth T of the slot die 34 can be regulated by means of plates 36, which can be moved in and out from the side into the slot 34. By way of the slot depth T it is also possible to adjust the thickness of the film 12. The slot width Z can likewise be adjusted. Provided for this purpose are further plates 38, which in this example can be moved into the slot 34 and out of it in a substantially perpendicular direction of movement in relation to the movement of the first plates 36. By way of the plates 38 it is possible to preset the slot width Z, which corresponds approximately to the film width Z′. In the lower region, owing to cooling and/or the effect of gravity, the film typically has a smaller width Z″. In order to be able to package an article, such as an automobile, effectively, in other words at the front, at the back, on the top and at the sides, with a protective film 12 of hot-melt adhesive 14, 14′, the slot width Z, or film width Z′, is selected preferably such that it corresponds approximately to the width B of the article to be packaged plus twice the height H of the article to be packaged: Z=B+2H or Z′=B+2H or Z″=B+2H, in particular Z″=B+2H.

As apparent from FIGS. 1 to 3, the heatable melting container 28 of the preliminary melting region 26 is filled by way of a charging means 30, which in this case takes the form of a hopper, with solid hot-melt adhesive 14′. In this example the solid hot-melt adhesive 14 is in the form of granules. Also conceivable, however, would be the supplying of the solid hot-melt adhesive 14′ in the form of powder, flakes, filaments, rods or blocks. In the melting container 28 the solid hot-melt adhesive 14′ is melted, if appropriate with stirring by means of the stirring means 24′. The, melted hot-melt adhesive 14 flows here via the line 32 into the container 22 of the primary melting region 18. In the heatable container 22 the melted, often fairly viscous hot-melt adhesive 14 is heated to the predetermined application temperature. This application temperature is harmonized with the temperature of the article to be packaged and with its thermal conductivity. For effective application, therefore, the article ought not to exhibit inherently any great temperature gradients. The application temperature is selected such that, as it flows off, the hot-melt adhesive 14 forms a film 12. The thickness of the protective film 12 is harmonized, in connection with the properties of the hot-melt adhesive 14, with the function that the protective film 12 is later to exercise, and with the form of the article to be packaged. Moreover, the film thickness and the rate at which the article to be packaged is moved transversely to the film 12 for the purpose of application are harmonized with one another. In this way it is possible to prevent the film tearing during the application process.

In the example shown in FIGS. 1 to 3, the protective film 12 of hot-melt adhesive 14, 14′ is intended for application as a self-adhesive protective film 12 to an automobile 10. As hot-melt adhesive 14, 14′, therefore, a thermoplastic hot-melt adhesive is selected which is based on polyester or on a polyamide or atactic poly-α-olefin, and whose resultant, self-adhesive protective film 12 is transparent, exhibits an appropriate initial adhesion and also an appropriate wind stability and weathering stability, and which, after use, can be removed again without residue and without tearing. An example of a hot-melt adhesive 14, 14′ of this kind is a high molecular weight, linear, partially crystalline, saturated polyester, having in particular a molecular weight of 15,000 to 20,000 g/mol.

The application temperature is selected such that the self-adhesive protective film 12 which results when the liquid hot-melt adhesive 14 flows off enters into sufficient wetting with the painted surface of the automobile 10, and the initial adhesion corresponds to the desired specifications. Effective wetting generally requires temperature differences between the article and the application temperature of 50° C. or more. The application temperature for the abovementioned hot-melt adhesive 14 is approximately 200° C., and the temperature of the automobile surface corresponds approximately to room temperature. In order that the self-adhesive protective film 12 composed of the stated hot-melt adhesive 14 can be applied to the automobile and is able to exercise the desired protective function, the film 12 is applied with a thickness of approximately 100 micrometers. In the example shown, the width Z′ of the self-adhesive protective film 12 and/or of the slot die 34 is set so that it corresponds to the width B plus twice the height H of the automobile 10.

For the application of the self-adhesive protective film 12 to the automobile 10 the latter is moved, as depicted in FIGS. 1 to 3, transversely to the film 12. For this movement it can be driven or, as is usual in automobile manufacture, conveyed by appropriate means. Harmonized in time with the approaching automobile, the liquid hot-melt adhesive 14, heated to application temperature, is enabled to flow off out of the slot die 34. The self-adhesive protective film 12 covers the automobile 10 and, as it does so, conforms to the automobile's 10 outer contours; cf. FIGS. 2 and 3. When the entire automobile 10 has been covered as viewed in the conveying direction, including its rear face, with film 12, the film 12 is severed (not shown) and the automobile 10 can be moved on. In order to achieve a close lie of the protective film 12 at points of difficult external contours and a firm bonding of the self-adhesive protective film 12 to the substrate, the automobile 10 covered with the self-adhesive protective film 12 is treated with hot air (not shown). As a result of this, the self-adhesive protective film 12 composed of the hot-melt adhesive 14, 14′ shrink-fits to the external contours of the automobile 10, with gaps being bridged, as depicted by way of example in FIGS. 4 and 5. The self-adhesive protective film 12 bonds firmly to the surface of the automobile 10. If appropriate, overhanging film 12 can then be removed and the automobile 10 is ready for transport and for storage outdoors. In this example the hot-melt adhesive 14, 14′ for the protective film is selected such that the self-adhesive protective film 12 is weathering-resistant and such that the protective film does not detach from the surface of the automobile even in a slipstream or in stormy gusts of wind. Intentional removal of the protective film, in particular in one piece, is possible without residue, in contrast.

FIGS. 4 and 5′ show the situation of a gap 40 between two fixed elements 42, 42′ of rectangular cross section, said gap 40 being covered with a protective film 12 of hot-melt adhesive 14, 14′. FIG. 4 shows the situation prior to treatment with hot air, FIG. 5 the situation after the hot air treatment. Clearly apparent in FIG. 5 is how the protective film 12, following the hot air treatment, conforms more closely to the outer contours of the fixed elements 42, 42′, but is stretched over the gap 40 and no longer follows the contour of the elements 42, 42′.

FIGS. 6 to 12 show the all-round packaging of an article 44 with a protective film 12 of a hot-melt adhesive 14, 14′, and also an embodiment of a device 16′ suitable for this packaging method.

The device 16′ shown in FIGS. 6 to 11 is in principle of the same construction as the device 16 described above in FIGS. 1 to 3. In contrast to the above-described device 16, however, in this case the heatable melting container 28 of the preliminary melting region is disposed above the container 22 of the primary melting region 18, and bordering it. The two containers 22, 28 communicate directly with one another through an opening 48 which can be closed by means of one or more closing elements 46. Thus the line 32 becomes redundant. For the sake of simplicity FIGS. 7 to 11 do not show the detail of the preliminary melting region 26, and only the heatable container 22 of the primary melting region, with the application unit 20, has been depicted. A further difference from the above-described device 16 is a supporting element 50 which is provided in this device 16′ and which is movable transversely to the film 12 in a first direction, arrow 52, and in an opposite second direction, arrow 54. Movement may be accomplished by means of driven transport rollers, by means of a hoist drive, or in other suitable fashion (not shown). The supporting element is preferably manufactured from a nonstick material, especially Teflon, or coated therewith, so that the self-adhesive protective film 12 does not stick to it.

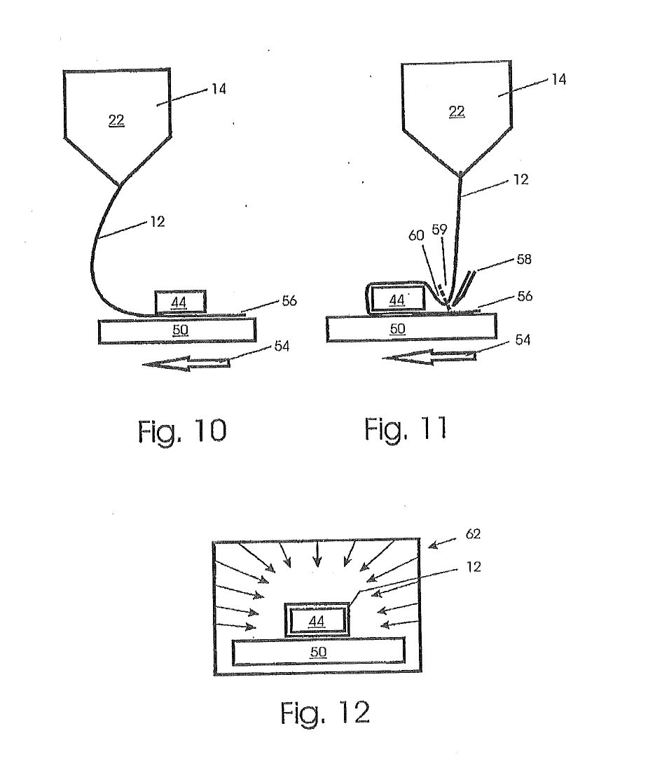

As apparent from FIGS. 6 to 11, the supporting element is moved in direction 52 transversely to the film 12, the protective film 12 being deposited as a sheet of film on the supporting element 50; cf. FIGS. 6 to 8. When a sufficiently large area of the supporting element 50 is covered with sheet of film, the article 44 to be packed is placed on the sheet of film; see FIG. 9. In this arrangement, the free end 56 of the sheet of film protrudes and shows in direction 52 beneath the article 44. The supporting element 50 is then moved in the opposite second direction 54, so that the article 44 is enwrapped by the protective film 12; FIGS. 10 and 11. For the article 44 to be deposited it is possible to halt the supporting element 50 for a short time; alternatively there may only be a change of direction, depending on how quickly the supporting element 50 is moved in the two directions 52, 54 and on how much time is needed for sufficiently accurate placing of the article 44. On enwrapment of the article 44 by the protective film 12, sufficient film 12 is pulled over the article 44 in direction 52 that, after the film 12 has been separated off, the second end 60 which is then free lies partially on the first free end 56. The separation of the film can be accomplished either by cutting, in particular on the supporting element 50, indicated by knife 58 and the dashed line 59, or, preferably, by the brief closing of the plates 36.

If the film width is selected as described above for FIGS. 1 to 3, moreover, the film, with its protruding edges, falls down over the sides of the article, so that the article 44 is completely enveloped. The supporting element 50 bearing the article 44 enwrapped in protective film 12 can then be moved into a hot air station 62, as shown in FIG. 12. Under hot air, the protruding sides and the two free ends 60 and 56 of the protective film 12 become welded to one another, and the protective film 12 shrink-fits to the article 44. The article 44 is then ready-packaged in protective film 12 and is well protected for transport and storage. Instead of hot air treatment it is also possible simply to weld the protruding side film edges and the free ends 60, 56. Such welding can take place, for example, using a welding die or a thin movable hot air nozzle.

If the protective film 12 is not self-adhesive, the application temperature can be selected such that there is no wetting, or only extremely inadequate wetting, with the product to be packaged. If the product to be protected, as described above for FIGS. 6 to 11, has been enwrapped by a non-self-adhesive protective film 12 of hot-melt adhesive 14, 14′, then it is possible likewise either to weld the film edges protruding at the sides and the free ends 60, 56 or else to shrink the film 12 onto the article 44 by means of hot air and to weld together all of the protruding edges and ends.

A supporting element 50 which is movable transversely to the film 12 can of course also be used if an article is to be only covered with the protective film 12, as was shown for the automobile in FIGS. 1 to 3. For an application of that kind it is necessary for the supporting element 50 to be movable only in one direction 52, and any hot air station present is then sited downstream of the application unit 20 in direction 52. A device which can be employed flexibly may of course have the various elements of the devices described, combined with one another in a rational manner, for both possibilities.

As shown, there are a variety of versions of the method for the application of protective films produced from a hot-melt adhesive 14, 14′, in which the protective film 12 of hot-melt adhesive 14, 14′ can be applied self-adhesively or else non-self-adhesively. However, beyond the possibilities presented here, there are further variations possible, involving, for example, a rational combination of different method elements shown, so that the versions of the method presented here are not limiting.

Similarly, beyond the embodiments of the device 16, 16′ for applying protective films 12 of hot-melt adhesive 14, 14′ that are depicted here graphically and described in detail, there are further embodiments of such devices. For example, the application unit 20 may also be formed, instead of being a slot die 34, from a multiplicity of small dies placed individually alongside one another. The width and the thickness of the film 12 which results from the flow off of the liquid hot-melt adhesive 14 can be regulated by switching dies in and out. Rather than by gravity, the flow off of the liquid hot-melt adhesive 14 can also be accomplished by means of pumps, under pressure. In such a case the film thickness may also be influenced by the pressure and hence via the amount of liquid hot-melt adhesive 14 flowing through the die 34 or the dies. Instead of a heatable container 22 with an integrated application unit 20 in the primary melting region 18, the application unit 20 may also be sited at a distance from the container 22. In that case the application unit 20 communicates with the container 22 via one or more supply lines, which supply the liquid hot-melt adhesive 14 to the application unit 20. These supply lines are preferably insulated or, in the case of longer lines, are preferably heatable, so that the liquid hot-melt adhesive 14 can be maintained at its application temperature. Under certain circumstances, for certain hot-melt adhesives 14, 14′, there is no need for the preliminary melting region 26; for example, for hot-melt adhesives 14, 14′ which are insensitive to oxidation or are in viscous form at room temperature. Plant operated only with hot-melt adhesives 14, 14′ of this kind need not, therefore, have a heatable melting container 28, so that the means for charging, 30, are provided in the heated container of the primary melting region 18. As means for charging it is possible, rather than hoppers, for filling ports or easily closable openings or pumps or extruders, etc. to be provided.

FIG. 13 shows a preferred embodiment of a device 16, in which, in comparison to FIG. 1, the preliminary melting region 26 represents a barrel pump. Mounted in this barrel pump is a barrel 27 in which a heatable follower plate 29 which is displaced by hydraulic means 31, a hydraulic press for example, melts the solid adhesive 14′ and pumps it as liquid adhesive 14 via a line 32 into the primary melting region 18. When the barrel 27 is pressed to empty, the follower plate 29 is withdrawn, a new, open barrel 27 is put in place, and the follower plate 29 is introduced again. During this changeover time, adhesive 14 no longer flows through the line. In order nevertheless to continue with the packaging operation, the primary melting region 18 requires a sufficiently large buffer volume so that the hot-melt adhesive is able to flow off continuously in the required amount.

FIG. 14 shows a diagrammatic representation of products enwrapped with protective films, which are printed. FIG. 14a) shows an article 44 enwrapped with protective film 12 which on the surface of the protective film 12 has an imprint with information, content 45 and imprints with advertising content 47. FIG. 14b) shows an automobile 10 which is protected with a protective film 12 whose surface carries an imprint with information content 45 and imprints with advertising content 47. In both representations a logo is shown as an example of an imprint with advertising content 47. Shown as an example of an imprint with information content 45 is an address and a barcode, respectively. The print out is applied, for example, by means of a printing apparatus, which is not shown, in particular an ink-jet printing head. The application of the imprint may take place downstream in the packaging line or subsequently outside of the packaging line.

As this shows, there are a very wide variety of embodiments conceivable for the device as well. The variations and combinations thereof that are shown are therefore not limiting. Nor should the hot-melt adhesives 14, 14′ described in more detail be regarded as limiting, either.

### EXAMPLES

The materials indicated in table 1 were melted and applied hot to a painted metal automobile panel. On cooling, the film was evaluated by finger for tack and softness. The evaluation key employed for this purpose was as follows:
+ nontacky, suitable
∘ slightly tacky, still suitable
− tacky, unsuitable

TABLE 1
Suitability as hot-melt adhesive - tack

| Number | Material | Basis | 60° C. | 70° C. | 80° C. |
|---|---|---|---|---|---|
| K1 | SikaMelt 9170 | atactic poly-α-olefin | + | + | + |
| K2 | Tivomelt 9058/90 | atactic poly-α-olefin | + | + | + |
| K3 | Vestoplast 408 | atactic poly-α-olefin | + | + | + |
| K5 | UNI-REZ 2620 | polyamide | + | + | + |
| K7 | UNI-REZ 2635 | polyamide | + | + | ∘ |
| K10 | PES 1 | polyester BD/HD/T/IP^{X} | + | + | + |
| | | MW = 15 000-20 000 g/mol | | | |
| | | softening point = 130° C.* | | | |
| K11 | PES 2 | polyester BD/HD/T/IP^{X} | + | + | + |
| | | MW = 15 000-20 000 g/mol | | | |
| | | softening point = 118° C.* | | | |
| K12 | PES 3 | polyester BD/T/IP^{X} | + | + | + |
| | | MW = 15 000-20 000 g/mol | | | |
| | | softening point = 142° C.* | | | |
| K13 | PES 4 | polyester BD/T/IP/A^{X} | + | + | + |
| | | MW = 15 000-20 000 g/mol | | | |
| | | softening point = 135° C.* | | | |
| K14 | PES 5 | polyester BD/T/IP^{X} | + | + | + |
| | | MW = 15 000-20 000 g/mol | | | |
| | | softening point = 138° C.* | | | |

*Ring + ball, based on DIN ISO 4625
^{X}BD = butanediol, HD = hexanediol, T = terephthalic acid, IP = isophthalic acid, A = adipic acid

In addition, a weathering test to DIN 53387 was performed on K13 and K14. For this test K13 and K14 were melted and applied hot to painted metal automobile panels in a film 100 micrometers thick, using a doctor blade. After it had cooled, the coated panel was subjected to the artificial weathering test of DIN 53387 for 1000 hours.

TABLE 2
Properties after weathering test

| | | | Properties after 1000 h |
|---|---|---|---|
| Number | Material | Basis | weathering |
| K13 | PES 4 | polyester | good panel adhesion |
| | | | readily removable |
| | | | very suitable |
| K14 | PES 5 | polyester | good panel adhesion |
| | | | readily removable |
| | | | highly suitable |

List of reference symbols

| H | height |
|---|---|
| B | width |
| T | slot depth |
| Z | slot width |
| Z′ | film width |
| Z″ | film width in lower region |
| 10 | automobile |
| 12 | film, protective film |
| 14 | hot-melt adhesive (liquid) |
| 14′ | hot-melt adhesive (solid) |
| 16, 16′ | device |
| 18 | primary melting region |
| 20 | application unit |
| 22 | heatable container |
| 24, 24′ | stirring means |
| 26 | preliminary melting region |
| 27 | barrel |
| 28 | heatable melting container |
| 29 | heatable follower plate |
| 30 | means for charging |
| 31 | hydraulic means |
| 32 | line |
| 34 | slot die |
| 36 | plates |
| 38 | further plates |
| 40 | gap |
| 42, 42′ | solid elements |
| 44 | article |
| 46 | closing element |
| 48 | opening |
| 50 | supporting element |
| 52 | first direction |
| 54 | second direction |
| 56 | free end |
| 58 | knife |
| 59 | dashed line |
| 60 | second free end |
| 62 | hot air station |

1.-6. (canceled)

7. A method of applying a protective film, directly to a product to be protected wherein a hot-melt adhesive is heated in a primary melting region to an application temperature, in that it subsequently flows off out of the primary melting region, the flow-off and application temperature being regulated such that a film of desired width is formed, and in that the product to be protected with the film is moved transversely to the film in such a way that the film covers the product in desired fashion.

8. The method of claim 7, wherein the film width (Z′) on emergence from the primary melting region is set so as to correspond approximately to the width (B) of the product to be protected with the film, plus twice the height (H) of the product.

9. The method of claim 7 wherein the hot-melt adhesive is heated to an application temperature situated in the range from 80° and 250° C., the hot-melt adhesive being melted in a preliminary melting region before being heated in the primary melting region to the application temperature.

10. The method of claim 7, wherein the protective film is used as a self-adhesive protective film and for this purpose the temperature of the product to which the self-adhesive protective film is intended to adhere and the application temperature of the hot-melt adhesive are harmonized with one another such that the protective film enters into sufficient wetting with the surface of the product, the temperature difference between the product and the application temperature being at least 50° C.

11. The method of claim 7, wherein the surface temperature of the product to be protected is not more than 80° C. and not less than 0° C.

12. The method of claim 7, wherein the protective film flows off onto a repellently coated supporting element, which is moved transversely to the film in a first direction, so that a sheet of film is deposited on the supporting element, in that the product to be protected with the protective film is placed on the sheet of film deposited on the supporting element and the supporting element is then moved in an opposite second direction transversely to the film, so that the product is enwrapped in the protective film.

13. The method of claim 7, wherein the protective film is separated off to a desired length.

14. The method of claim 7, wherein the product covered with the protective film is treated with hot air so that the film shrink-fits to the outer contours of the product.

15. A device for applying a protective film of hot-melt adhesive, directly to a product to be protected having a primary melting region, in which the hot-melt adhesive is heated to its application temperature, and having an application unit via which the liquefied hot-melt adhesive flows off in such a way that it forms a coherent film of predetermined width and predetermined thickness.

16. The device of claim 15, wherein the application unit is in the form of a slot die whose slot depth (T) and slot width (Z) are adjustable, and in particular are adjustable in such a way that the width (Z′) of the resulting film corresponds approximately to the width (B) of the product to be protected with the film, plus twice the height (H) of the product.

17. The device of claim 15, wherein it has a preliminary melting region which is upstream of the primary melting region and in which the hot-melt adhesive is melted.

18. The device of claim 15, wherein a supporting element is provided for accommodating the product to be protected with the protective film, the supporting element being preferably coated in such a way that the protective film does not stick to it.

19.-21. (canceled)

22. The method according to claim 7, wherein the film applied to the object to be protected is unbacked.

23. The device according to claim 15, wherein the film applied to the object to be protected is unbacked.

24. The method of claim 7, wherein the film is formed from a thermoplastic hot-melt adhesive based on a substance from the following group of substances: thermoplastic polyurethanes, thermoplastic polyamides, thermoplastic copolyamides, thermoplastic polyesters, thermoplastic copolyesters, thermoplastic polyolefins, especially atactic poly-α-olefins, polypropylene or polyethylene, thermoplastic ethylene/vinyl acetate copolymers or a combination thereof.

25. The protective film of claim 15, wherein the film is formed from a thermoplastic hot-melt adhesive based on a substance from the following group of substances: thermoplastic polyurethanes, thermoplastic polyamides, thermoplastic copolyamides, thermoplastic polyesters, thermoplastic copolyesters, thermoplastic polyolefins, especially atactic poly-α-olefins, polypropylene or polyethylene, thermoplastic ethylene/vinyl acetate copolymers or a combination thereof.
